(19) United States
(12) Patent Application Publication
(10) Pub. No.: US 2006/0015573 A1
(43) Pub. Date: Jan. 19, 2006

(54) System and method for automatic redirection to stored web resources upon access failure

(75) Inventors: Oliver Hurst-Hiller, Seattle, WA (US); Brett D. Brewer, Sammamish, WA (US)

Correspondence Address: SHOOK, HARDY & BACON LLP;INTELLECTUAL PROPERTY DEPARTMENT, 2555 GRAND BLVD, KANSAS CITY,, MO, 64108-2613, US

(73) Assignee: Microsoft Corporation, Redmond, WA (US)

(21) Appl. No.: 10/879,001

(22) Filed: Jun. 30, 2004

(51) Int. Cl. G06F 15/16

(52) U.S. Cl. 709/218

(57) ABSTRACT

A system and related techniques monitor a user's attempt to access a Web site or other network site, and detect failed access attempts such as HTTP 404 messages or others. Rather than pass the access failure message directly through to the user, the system may communicate with a search service or other index of stored or cached Web pages or other content images. The user may be given a choice via a dialogue to view a stored version of the site they were attempting to access, so that some or all of the desired information may still be accessed. In embodiments, the user may be directed to differing sources of the identical or similar desired content, via a priority stack. If further embodiments, the operator of the Web site or other content source may choose to apply a cached content override to opt out of making stored content available to searchers or other users, for example for digital rights management purposes.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of networked computing, and more particularly to a system and related techniques for detecting the occurrence of a failed Web link or other network access attempt, and selectively redirecting the user to a stored or cached version of that site.

### BACKGROUND OF THE INVENTION

Users browsing the Web and other network sites sometimes encounter the experience of attempting to click a link to a site, only to receive an error message such as “Error 404 File Not Found” or other indication that the destination page or site is not available or accessible. This may occur, for example, when a user has used an Internet search service to execute a search for desired search terms, and been presented with a set of search results for selection. When a desired link from that set of results has been clicked through or otherwise activated but returns an error message, the user may have to retrace their steps back to the search results list or navigate to another Web site to continue their search or other activity. In general encountering such dead link errors is not productive and conveys little more information than that the desired site is unavailable, often for unknown reasons. If the user remains interested in accessing the failed Web site, they may have to wait a random amount of time to try to access that site again, to see if it has come back online.

Web browsing, search execution and other networked and other activities may therefore channel the user's experience to a non-productive or unhelpful error state when access issues are encountered. This may occur even though the Web browser or other search or navigation tool may be capable of detecting the occurrence of an access failure, to potentially divert the user to other resources. Other problems and shortcomings in Internet search and navigation technology exist.

### SUMMARY OF THE INVENTION

The invention overcoming these and other problems in the art relates in one regard to a system and method for automatic redirection of a user to a stored Web image or other networked content, upon the detection of an access failure. In embodiments, a Web browser or other application may be configured with a search control tool or other logic to monitor and detect the occurrence of an access failure, such as a dead or non-responsive Web link or other inoperative address or connection. Upon detection of an access failure, according to embodiments the Web browser or other application may communicate with a search service, such as an Internet search service, to notify that resource of the attempted access and lack of response. The search service may respond to that notification by transmitting to the browser a cached or stored copy of the Web site or other destination which the user intended to access. That stored content or media may for example be retrieved from a search index or other image store. In embodiments, when an access failure occurs the user may be presented with a dialogue indicating that the desired live site was unavailable, but that the user may choose to view a cached or stored copy or image of that page or site. The user may thus be able to view some or all of the content hosted on that desired site, despite the access interruption. In embodiments, the user may likewise be redirected to a sequence of alternate sites or sources, based on a content priority stack. In further embodiments, a Web site operator may communicate an access override command to the search service to decline to present searchers or other users with stored copies of its site or content, for example for digital rights management or other purposes.

### BRIEF DESCRIPTION OF THE DRAWINGS

FIG. 1 illustrates an environment in which a system and method for automatic redirection to a stored Web image upon access failure may operate, according to embodiments of the invention.

FIG. 2 illustrates a content priority stack which may be employed to direct access to a set of alternate content sources, according to an embodiment of the invention.

FIG. 3 illustrates a system and method for automatic redirection to a stored Web image upon access failure according to embodiments of the invention, in which in one regard a content provider may override or opt out of stored content redirection.

FIG. 4 illustrates a flowchart of overall redirection processing, according to embodiments of the invention.

### DETAILED DESCRIPTION OF EMBODIMENTS

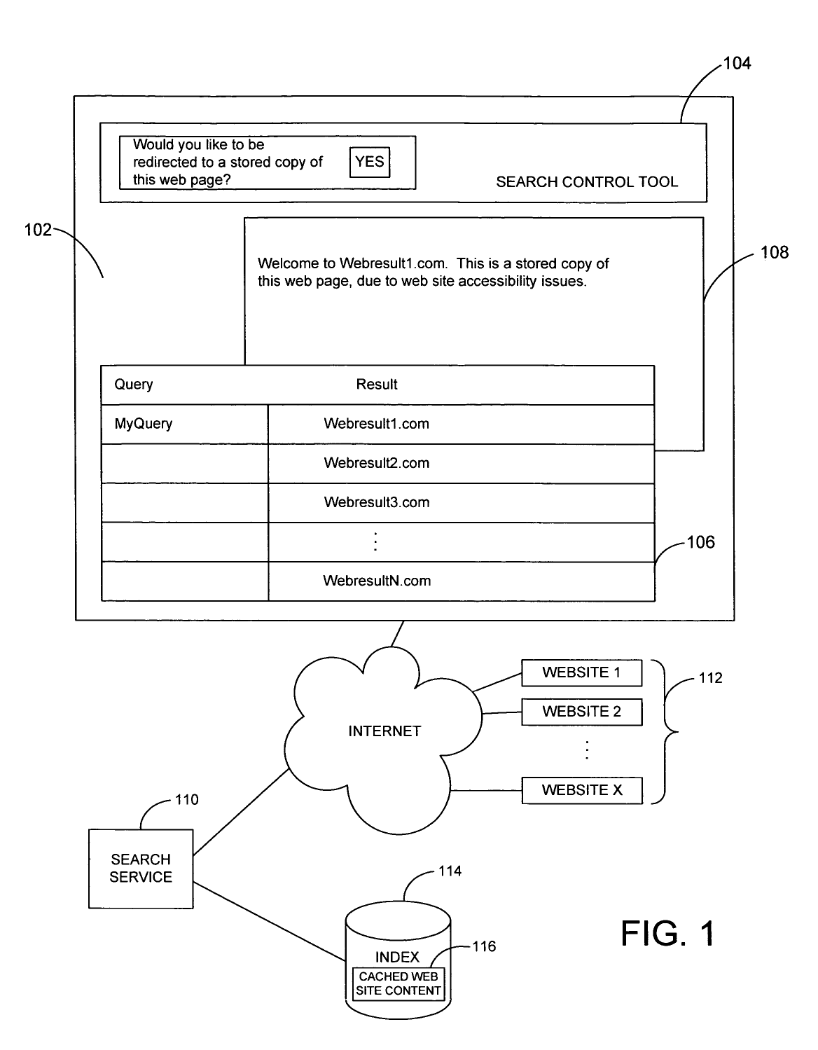

FIG. 1 illustrates an environment in which a system and method for automatic redirection to a stored Web image upon access failure may operate, according to an embodiment of the invention. As illustrated in that figure, a user may operate an interface 102, such as an interface included within a Web browser or other application or resource, to perform a variety of networked and other tasks. The interface 102 for example may be presented on and control the operation of a program on a personal computer or other client or device. In embodiments as shown, the user may more particularly operate the interface 102 to perform networked searches, for example accessing a search service 110, such as an Internet-based or Internet-accessible search engine or service. The user may perform those searches by inputting or identifying desired text, images or other terms or inputs to the search service 110. The user may also be presented with a search control tool 104 to operate within or in conjunction with the interface 102, to manage the display of search results and other content as described herein.

In embodiments as illustrated, the user may be presented with a set of search results 106 generated via the search service 110, for example a set of Web links or other results or sites which correspond to the user's desired search terms or content. The search results 106 may for instance contain a set of links to a set of Web sites 112 which contain text, images or other content or material corresponding to the user's search terms. According to the invention in one regard, the user may access any one or more of the search results 106, for example by highlighting, clicking, or otherwise accessing or activating the links for those results. According to the invention in a further regard, the user's attempt to access a Web site, for example “Webresult1” as shown, may result in an access failure. That is, the Web link or other network site or address encapsulated in the selected search results 106 may not successfully retrieve an associated Web page or other Internet or other site, when clicked or otherwise activated.

This may occur, for example, when a browser or other application or resource attempts to connect to the linked site using TCP/IP (transfer control protocol/Internet protocol) or other protocols via the Internet, for example using port 80 or another network port assignment, but receives an error message or notification that the target page or site can not be accessed. This may be indicated, for example, by a hyper text transfer protocol (HTTP) error code such as “Error 404 File Not Found”, “Error 204 No Content”, a DNS (Domain Name System) error such as “11004 Host Not Found”, or other errors, flags or messages. For example, in embodiments an access failure may be detected and registered when a Web site successfully responds to an access attempt via HTTP, but does so with a customized Web error page rather than its regular content (so-called “soft 404” error). Those error or failure indicators may likewise be delivered or received through other ports, sockets, protocols or channels. Access failures may in further embodiments likewise be detected and trapped during other activities not related or directly related to search activities or attempts, for example, during Web browsing when a typed HTTP address fails, or at other times.

When it occurs, the access failure may for example be detected and trapped by the search control tool 104, but may in embodiments also or instead be detected via search service 110 or other resources, for example in communication with interface 102, search control tool 104 or in cooperation with other applications or resources.

When an access failure is detected, according to embodiments of the invention the search control tool 104 may for example present the user with a dialogue to selectively present an alternate copy, version or image of the Web page or site which the user had intended to view during the failed access attempt. More particularly, and as shown in FIG. 1, when an access failure is detected the search control tool 104 may for example query the user whether they wish to view or be redirected to a stored or cached copy of the Web page, site or other linked address or resource. If the user responds in the affirmative, for instance via a mouse click, the search control tool 104 may communicate with the search service 110 to identify, retrieve and communicate a stored Web image or other content corresponding to the page or site to which the access attempt failed. In further embodiments, rather than be presented with a dialogue upon the occurrence of each access failure, the user may select a global setting in search control tool 104 or otherwise to apply a preference to all such events, such as to always view or always reject stored or cached content. Other control arrangements are possible.

According to embodiments of the invention, and supporting those failover purposes, in one regard the search service 110 may maintain or interface to an index 114 of networked site content, for example a Web index of available Web pages or sites, which may for instance be generated using Web crawlers and other gathering tools. The index 114 may store a set of cached Web site content 116, for example images or copies of HTML (hyper text markup language), XML (extensible markup language) or other Web pages, text files such as Microsoft Word™ files, Microsoft PowerPoint™ or other slideshow or presentation files, spreadsheet files such as Microsoft Excel™ files, database files, graphical images such as JPG (joint photographic experts group) or other graphical files or formats, Adobe PDF (portable document format) documents or files, media such as audio or video samples, for example in MP3 (motion pictures experts group level 2, layer 3), Windows™ AVI or Real formats, or other documents, files, media or other Internet-based or other content. In embodiments cached Web site content 116 may be encoded and stored in other formats, languages or protocols, as well.

When an access failure from the set of search results 106 is detected and the user responds to selectively display a cached or stored image of the intended page or site, search service 110 may communicate with index 114 to identify and retrieve a copy of stored Web image 108 of that page or site for presentation to the user. The stored Web image 108 may be identified in the set of cached Web site content 116 for instance by its identifying HTTP address or other network address, pointer, or indicator. The stored Web image 108 retrieved in this manner may be presented on interface 102, for example as a new browser window, or otherwise. The interface 102 and/or the stored Web image 108 may in one regard contain a notice to indicate to the user that the content or media being presented represents a copy or image of the live page or site, so that the user may not, for example, expect or attempt to perform certain activities that would be possible at that page or site, such as attempt to enter an account number or otherwise interact with that page.

The stored Web image 108 may in cases present the identical content as the live page or site to which access has failed, and in embodiments, may itself contain other links to certain other operable sites or resources, for example to affiliated operating sites. Because the user may be able to derive useful information from the stored Web image 108 despite a dead link or other failed access, the user's search, navigation or other experience may be enhanced. It may be noted that according to embodiments of the invention in another regard, the search service 110 may also maintain or retrieve logs or other data regarding failure rates for referenced Web sites, so that the search result rating algorithms used by search service 110 may, for instance, be trained or adjusted to reduce the search result ratings for frequently downed sites.

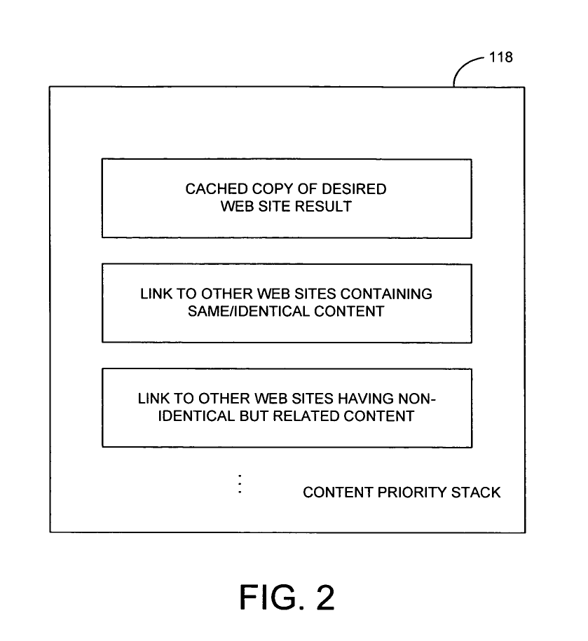

According to further embodiments of the invention, the alternate content delivered to the user when access to a desired Web page or other site has failed may be presented from a hierarchy or sequence of possible content sources. More particularly, as illustrated in FIG. 2, a content priority stack 118 may control the ordering of stored multiple Web page images and other alternate content sources, according to further embodiments of the invention. That is, upon detection of an access failure, in embodiments the search control tool 104 and/or search service 110 or other resources may access the content priority stack 118 to determine a sequence of alternate content sources to access in place of the page or site to which access failed. As illustrated, the content priority stack 118 may record a set of sources to be accessed in order, beginning, for example, with the stored Web image 108 or other cached copy of a desired Web site, followed by links or connections to other Web sites which contain the same or identical content as the page or site to which access has failed. In embodiments the content priority stack 118 may be hosted or maintained in the search service 110, or elsewhere. In further embodiments, the sequence encoded in content priority stack 118 may be customized for individual users or groups of users, for instance by the search service 110, or by the users themselves.

A next alternate source governed by content priority stack 118 may be or include links or connections to other Web or other sites containing material or content which is not identical, but instead similar or related to the content of the page or site to which access failed. Other alternate sources and orders of those sources are possible. It may be noted that in the sequence of alternate sources recorded in content priority stack 118, one or more of those sources may be accessible via live Web or other links, rather than necessarily being retrievable via index 114. Other configurations are possible.

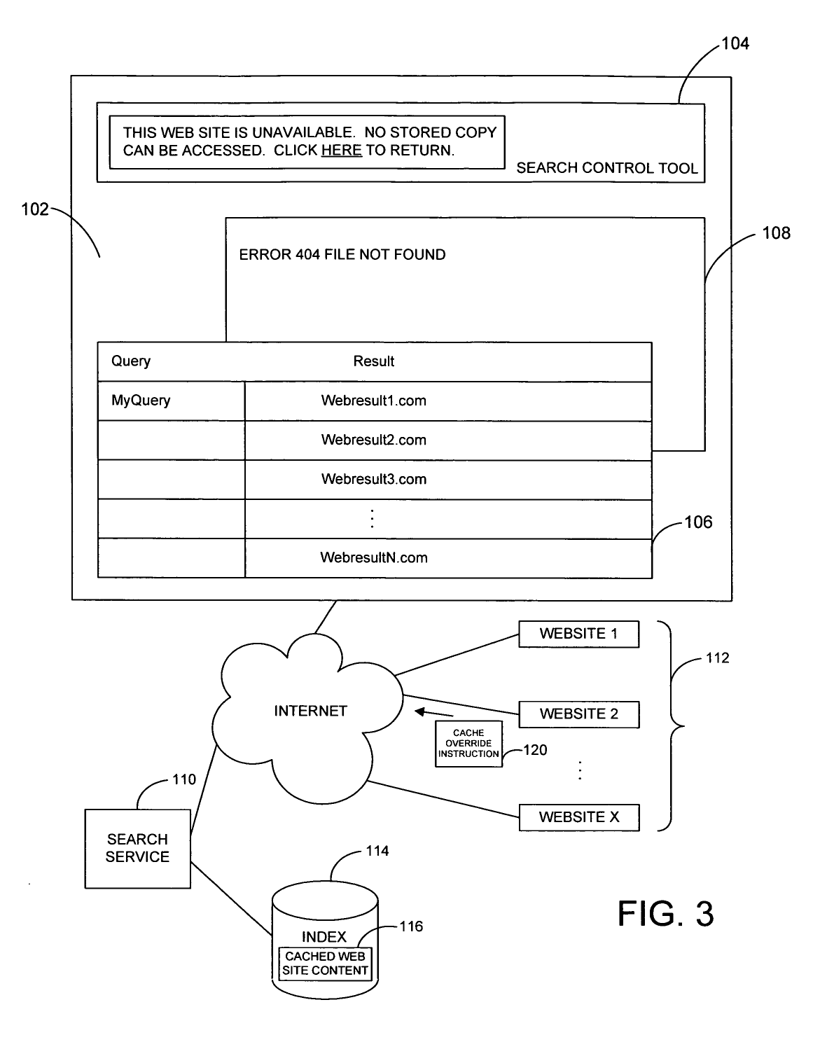

According to further embodiments of the invention illustrated in FIG. 3, delivery of the cached Web site content 116 may in certain regards be further managed and controlled by the set of Web sites 112 whose content is reflected in index 114, or others. More specifically, for example in the case of a participating Web site or other source hosting musical, video, graphical or other content which may be protected by digital rights management, the owners or operators of the associated Web sites may not wish to deploy or store images of that content in a stored index, due to security, copyright and other concerns. According to embodiments of the invention illustrated in FIG. 3, therefore, one or more Web site or other operator or others may communicate a cache override instruction 120 to the search service 110 or other resources, to prevent the generation or distribution of stored copies or images of that content in index 114 or other data stores.

Upon registration of cache override instruction 120, the search service 110 or other service or operator may delete or inactivate the corresponding cached content from the transmitting Web site. In embodiments this may include, for example, deletion from content priority stack 118 when implemented. Thereafter, upon detection of an access failure the search control tool 104 may present the user with an “Error 404 File Not Found” or other notice or flag, without displaying or presenting a dialogue to display a stored version of that content. Unauthorized reproductions of that content may in one regard therefore be prevented. According to embodiments of the invention in another regard, the site's cache override instruction 120 may likewise direct the search service 110 to divert the user to another Web page or site, for example a related Web page or site, present a custom error page, or perform other actions.

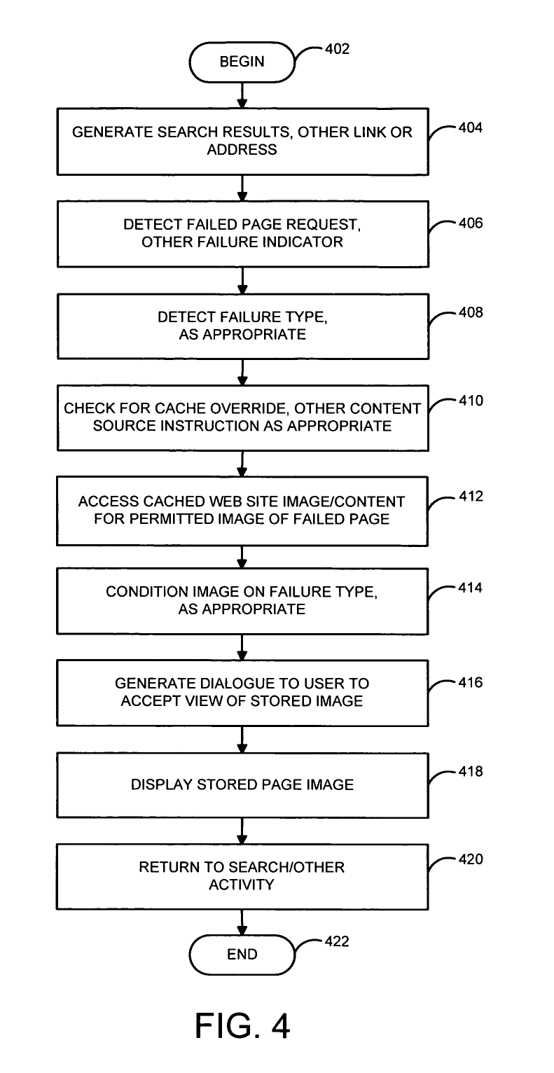

FIG. 4 illustrates a flowchart of automatic content redirection processing, according to embodiments of the invention. In step 402, processing may begin. In step 404, a search via search service 110 or other application or service may generate a set of search results 106 or other links, addresses or sites, such as Web sites containing text matching search terms inputted by the user. In step 406, the search control tool 104 and/or search service 110 may detect a failed page link or other access request, for instance via user selection, clicking or other activation of a link within the search results 106. The failed access request may be detected, for example, by monitoring port 80 for an HTTP message, such as “Error 404 File Not Found”, “Error 204 No Content”, a DNS error such as “11004 Host Not Found”, or other errors, flags or messages. In embodiments, the search control tool 104 may for instance detect errors by monitoring an event stack generated by a browser or other application, which may for example be monitored via browser application programming interfaces (APIs) exposed by the operating system, or other resources. Those messages may for example in embodiments also be delivered via other ports, sockets, protocols or channels.

In step 408, the search control tool 104 and/or search service 110 may detect a failure type, such as an HTTP 404 or other error code, as appropriate. In step 410, a determination may be made whether a cache override instruction 120 or other direction has been registered for the Web site among the set of Web sites 112 or other sources to which the selected Web link points. In step 412, the search service 110 may access the cached Web site content 116 from index 114 or other source or store of Web page or other cached images to retrieve a stored Web image 108 of the page or site corresponding to the failed link. In step 414, the stored Web image 108 corresponding to the failed access link may in embodiments be conditioned on the type of error detected, as appropriate. For example, an access request to a single page which fails may be directed to a stored image of that page, in expectation for example that the overall host site remains stable and the failed page may come back online in a relatively brief time. On the other hand, an access request to an entire domain name which has failed may be directed to an associated or affiliated Web site, since the status of that domain name site may be indeterminate. Other conditions or criteria on types of redirection are possible. For example, in embodiments affiliated, related or unrelated third party Web sites or their proxies may bid or register themselves to be fail-over candidates for inoperative Web sites of different types. In such embodiments, for instance, online shopping traffic directed to one vendor may in cases be redirected to another vendor marketing similar goods or services. Other redirection criteria are possible.

In step 416, a dialogue, for example a dialogue text box, set of button selectors or other interface may be presented to the user, to query the user to accept the viewing of the stored Web image 108, rather than a live site connection. In step 418 the stored Web image 108 may be presented to the user upon acceptance. In step 420, the user may return to search or other activities, for example by navigating a browser or other application back to the search results 106 or other location. In step 422, processing may repeat, return to a prior processing point, jump to a further processing point or end.

The foregoing description of the invention is illustrative, and modifications in configuration and implementation will occur to persons skilled in the art. For instance, while the invention has generally been described in terms of a single search service 110 which acquires Web page images and other stored content from a single index 114, in embodiments more than one search or other service or application may access more than one index or other image or content store, to distribute content to users. The same cached content may likewise be distributed to more than one user.

Similarly, while the invention has in embodiments generally been described as operating with a search control tool 114 embedded with or operating in conjunction with a browser, in embodiments the control logic for detecting and managing access failures and alternately-sourced content may be embedded in or distributed across other applications, the operating system or other resources. For further instance, in implementations a browser or other application system may omit installation of search control tool 104, but still operate according to embodiments of the invention to receive redirected content under control of the search service 110 or other resource. Other hardware, software or other resources described as singular may in embodiments be distributed, and similarly in embodiments resources described as distributed may be combined. The scope of the invention is accordingly intended to be limited only by the following claims.

We claim:

1. A system for redirecting stored content to a user upon a network access failure, comprising:
a first interface to a user navigation interface;
a second interface to a cached content store; and
a control engine, the control engine communicating with the first interface to detect an access failure via the user navigation interface and with the second interface, the control engine redirecting stored content retrieved via the cached content store to the user upon the detected access failure.

2. A system according to claim 1, wherein the user navigation interface comprises a browser.

3. A system according to claim 2, wherein the browser interfaces to a search service.

4. A system according to claim 3, wherein the browser presents a set of search results from the search service.

5. A system according to claim 4, wherein the access failure comprises an inoperative link within the set of search results.

6. A system according to claim 2, wherein the control engine is embedded in the browser.

7. A system according to claim 1, wherein the cached content store comprises a Web index.

8. A system according to claim 1, wherein the access failure comprises an inoperative network address.

9. A system according to claim 8, wherein the inoperative network address comprises an inoperative Internet address.

10. A system according to claim 1, wherein the control engine presents the user with a dialogue to selectively display the stored content based on user input.

11. A system according to claim 1, wherein a source of the stored content may transmit an access control instruction, the access control instruction controlling display of the stored content via the control engine.

12. A system according to claim 1, wherein the control engine directs the stored content according to a content priority stack.

13. A system according to claim 12, wherein the content priority stack comprises at least the content of a site intended to be accessed by the failed access, a site containing identical content to the site intended to be accessed by the failed access, and a set of sites containing similar content to the content of the site intended to be accessed by the failed access.

14. A method for redirecting stored content to a user upon a network access failure, comprising:
detecting an access failure via a user navigation interface; and
redirecting stored content retrieved from a cached content store to the user upon the detecting of an access failure.

15. A method according to claim 14, wherein the user navigation interface comprises a browser.

16. A method according to claim 15, wherein the browser interfaces to a search service.

17. A method according to claim 16, further comprising presenting a set of search results from the search service via the browser.

18. A method according to claim 17, wherein the access failure comprises an inoperative link within the set of search results.

19. A method according to claim 14, wherein the cached content store comprises a Web index.

20. A method according to claim 14, wherein the access failure comprises an inoperative network address.

21. A method according to claim 20, wherein the inoperative network address comprises an inoperative Internet address.

22. A method according to claim 14, further comprising presenting the user with a dialogue to selectively display the stored content based on user input.

23. A method according to claim 14, further comprising transmitting an access control instruction from a source of the stored content, the access control instruction controlling display of the stored content.

24. A method according to claim 14, wherein the stored content is directed according to a content priority stack.

25. A method according to claim 24, wherein the content priority stack comprises at least the content of a site intended to be accessed by the failed access, a site containing identical content to the site intended to be accessed by the failed access, and a set of sites containing similar content to the content of the site intended to be accessed by the failed access.

26. Stored content, the stored content being redirected to a user upon a network access failure according to a method comprising:
detecting an access failure via a user navigation interface; and
redirecting stored content retrieved from a cached content store to the user upon the detecting of an access failure.

27. Stored content according to claim 26, wherein the user navigation interface comprises a browser.

28. Stored content according to claim 27, wherein the browser interfaces to a search service.

29. Stored content according to claim 28, wherein the method further comprises presenting a set of search results from the search service via the browser.

30. Stored content according to claim 29, wherein the access failure comprises an inoperative link within the set of search results.

31. Stored content according to claim 26, wherein the cached content store comprises a Web index.

32. Stored content according to claim 26, wherein the access failure comprises an inoperative network address.

33. Stored content according to claim 32, wherein the inoperative network address comprises an inoperative Internet address.

34. Stored content according to claim 26, wherein the method further comprises presenting the user with a dialogue to selectively display the stored content based on user input.

35. Stored content according to claim 26, wherein the method further comprises transmitting an access control instruction from a source of the stored content, the access control instruction controlling display of the stored content.

36. Stored content according to claim 26, wherein the method further comprises directing the stored content according to a content priority stack.

37. Stored content according to claim 36, wherein the content priority stack comprises at least the content of a site intended to be accessed by the failed access, a site containing identical content to the site intended to be accessed by the failed access, and a set of sites containing similar content to the content of the site intended to be accessed by the failed access.
